(19) United States
(12) Patent Application Publication
(10) Pub. No.: US 2006/0261104 A1
(43) Pub. Date: Nov. 23, 2006

(54) Multiply configurable load carrying apparatus

(76) Inventor: John Vincent Zambrzycki, Redwood City, CA (US)

Correspondence Address: John V. Zambrzycki, 1123 King Street, Redwood City, CA, 94061, US

(21) Appl. No.: 11/132,382

(22) Filed: May 19, 2005

(51) Int. Cl. A61G 1/00; A45C 15/00; A45F 4/00; A61G 5/00

(52) U.S. Cl. 224/158; 224/160; 224/581

(57) ABSTRACT

A multiply configurable load carrying apparatus has been provided, which comprises a harness and a removably attachable load restraining device, each of which may be operated and used independently. A load may be positioned and secured in said load restraining device without the need of said load restraining device to be operable affixed to said harness, and the harness may be configured and secured to the wearer without requiring the attachment of the load restraining device.

### TECHNICAL FIELD

The present invention relates to torso mounted load carrying apparatuses in general, and to child/infant carriers in particular.

### BACKGROUND OF THE INVENTION

The use of load/infant carriers is known in the prior art. More specifically, devices heretofore devised and utilized for the purpose of carrying loads, and in particular small juveniles, children and infants are known to consist basically of familiar, expected and obvious structural configurations, notwithstanding the myriad of designs encompassed by the crowded prior art which have been developed.

By way of example, the prior art discloses in U.S. Pat. No. 4,149,687 to Nunemacher, discloses a baby pouch. U.S. Pat. No. 4,333,591 to Case, discloses a baby backpack sack. U.S. Pat. No. 4,402,440 to Purtzer et al., discloses an infant carrier. U.S. Pat. No. 4,428,514 to Elf, discloses an infant carrier. U.S. Pat. No. 4,467,945 to Schaapveld, discloses a baby carrier. U.S. Pat. No. 4,469,259 to Krich et al., discloses a baby carrier. U.S. Pat. No. 4,492,326 to Storm, discloses a sling-type infant carrier. U.S. Pat. No. 4,579,264 to Napolitano, discloses a baby carrying device. U.S. Pat. No. 4,724,988 to Tucker, discloses an infant carrier. U.S. Pat. No. 4,903,873 to Poole et al., discloses an infant carrier for use in an aqueous environment. U.S. Pat. No. 4,986,458 to Linday, discloses an infant carrier. U.S. Pat. No. 5,020,709 to Hoaglan, discloses a convertible child carrier. U.S. Pat. No. 5,176,102 to Tracy discloses a pet carrier. U.S. Pat. No. 5,178,309 to Bicheler et al., discloses an infant carrier and harness combination. U.S. Pat. No. 5,205,450 to Derosier, discloses a child carrier. U.S. Pat. No. Des. 357,800 to Roan et al., discloses a soft baby carrier. Lastly, U.S. Pat. No. 4,037,764 to Almosnino et al., discloses a child carrier.

All of the prior art however fails to resolve certain fundamental problems with such load/child carrying devices, namely the ability to secure the load/child to/in the carrying compartment without having the compartment attached to a harness, and the ability to removably attach the compartment to a harness in at least one of multiple locations without having to re-secure the load/child.

Thus, there is a need in the art for a multiply configurable load carrying apparatus wherein a harness can be secured to an individual without the need for the carrying apparatus to be permanently or operably attached to the harness, a load can be secured to/in a carrying apparatus without requiring the carrying apparatus to be permanently or operably attached to the harness, and wherein a carrying apparatus can be removably attached to the harness in various positions and/or orientations without having to remove the load, and without the load becoming unsecured.

### SUMMARY OF THE INVENTION

The invention comprises several general aspects. Each of those can if desired be combined with additional features, including features disclosed and/or not disclosed herein, the resultant combinations representing more detailed optional embodiments of these aspects.

According to a first aspect of this invention, a multiply configurable load carrying apparatus has been provided, which comprises a harness and a removably attachable load restraining device, wherein a load may be positioned and secured in said load restraining device without the need of said load restraining device to be operable affixed to said harness. In particular embodiments of the foregoing general aspect, the multiply configurable load carrying apparatus may be specifically tailored towards carrying infants and/or children.

The various additional features included in the various aspects and embodiments described below, even if described as embodiments drawn towards carrying a particular type of load, are equally applicable to any load capable of being carried. Additionally, multiple types of other load restraining devices may be attached other than those drawn towards restraining a child, for example, a tool satchel, a personal effects bag, or a child's changing/feeding supply sack.

In one embodiment of this first aspect, the harness may be secured to a person without requiring the attachment of the load restraining device.

In certain embodiments, the load restraining device and/or the load itself may be placed facing toward or away from the person. In certain other embodiments, the load restraining device and/or the load itself may be positioned vertically or horizontally.

In one embodiment, the load restraining device may be affixed to at least one of multiple locations on the harness. In various forms of the foregoing embodiment, the load restraining device may be affixed to the harness at a location roughly corresponding to a person's chest, back, and/or at or near the left and/or right hip.

In one embodiment, the load restraining device may be moved from one location on said harness to some other location on said harness without having to remove the load and/or without the load having to be unsecured and then re-secured to the load restraining device. Additionally, the load restraining device may be repositioned at its current location, for example reversing its orientation with respect to the harness, or changing from a vertical orientation to a horizontal orientation, without the load having to be removed and/or without the load having to be unsecured and the re-secured to the load restraining device.

In a further embodiment, the load restraining device may be transferred from a first person wearing a first harness to a second person wearing a second harness without having to remove the load and/or without the load having to be unsecured and then re-secured to the load restraining device. Additionally, the load restraining device, upon transfer, may have a position and/or orientation on the second harness different than the position and/or orientation it had on the first person's harness.

In yet another embodiment, said harness may be configured to have at least two load restraining devices attached to it at various points. In certain forms of the preceding embodiment said at least two load restraining devices may be of the same or different type.

In one embodiment, said harness may comprise at least two members, at least one first member circumnavigating said person's torso, and at least one second member connecting to said first member in at least two positions, wherein said second member crosses over at least one of said person's shoulders. Said first and/or second member(s) may be single integral pieces, or may comprise multiple component members.

In certain forms of this embodiment, the harness may comprise at least two first members which circumnavigate said person's torso. In certain other forms, said second member(s) may form a “Y”, “X”, “H”, or “double-H” as they cross from the front to the back of the person. In other forms of this embodiment, said first and/or second members may be adjustable in length. In still other forms, said first and/or second member(s) may have storage regions, which may be internal or external to said members.

In yet other embodiments, the load restraining device may be comprised of at least one of potentially multiple types of members. These members may be rigid, flexible, or semi-flexible, or may be some combination of rigid, flexible, and/or semi-flexible.

In certain forms of the preceding embodiments the load restraining device may comprise an essentially one-piece unit, foldable clamshell-like, in either a horizontal or vertical fashion. In other forms, the load restraining device may further comprise a total or partially sealable compartment or compartments. In still other forms, the load restraining device may comprise both mesh and solid material, said mesh being either widely spaced or fine.

In particular forms of these embodiments, the load restraining device may be specifically configured for use with or as: an infant/child carrier; a carrier of supplies for caring for an infant/child (e.g., clothes, diapers, food); a tools carrier for a random or specific set of tools; a generic food and/or water carrier; a parasol or other sun screening device; and/or personal effects carrier.

In those forms particularly configured for use with an infant/child, said load restraining device: may be sling-like, where said sling-like member may additionally comprise a foundational layer which allows the load to be carried horizontally; may comprise a platform for seating; may comprise an enclosure consisting of an opening for each of said child's legs, and at least one opening for said child's torso; or may comprise an enclosure consisting of an opening for each of said child's legs, an opening for each of said child's arms, and one opening for said child's head. In certain variations of these forms, the load restraining device's leg and/or arm openings may be adjustable. In other variations of these forms, adjustable straps may be used to secure the child's torso, said straps being able to be removably affixed to the restraining device and/or the harness.

In additional forms particularly configured for use with an infant/child, the load restraining device may also be provided in a pre-molded shape essentially configured to receive a child. In yet another form, the load restraining device may comprise a neck supporting member, and in certain variations of this form, the neck supporting member may be adjustable. Further variations of these forms include the incorporation of a removably attachable sun shade.

In certain variations of the preceding forms, the carrier may further included storage regions, wherein the storage regions may be internal and/or external.

### BRIEF DESCRIPTION OF THE DRAWINGS

The invention will be described in detail with reference to the accompanying drawings. Each of the Figures is a schematic diagram more fully described below.

FIG. 1 shows an embodiment of the present invention wherein a person 400 is wearing an example harness 100, attached to which is an example removably attachable load restraining device 200. In this example, the load restraining device, used as a child carrier 210, contains a child 310.

FIG. 2 shows the example harness 100 and carrier 210 from FIG. 1 separated.

FIG. 3 shows front and rear views of the example carrier 210 from FIG. 1.

FIGS. 4 and 5 show an example load restraining device used as an infant carrier 210 wherein the infant 310 faces either towards or away from the care giver.

FIGS. 6 and 7 show an example load restraining device used as an infant carrier 210 wherein the infant 310 is positioned either vertically or horizontally.

FIGS. 8 and 9 show the example harness 100 and load restraining device from FIG. 1 wherein the carrier 210 is removably affixed to the harness 100 in the area of the back and hip, respectively, of the person, as opposed to being affixed in the area of the chest, as shown in FIG. 1.

FIGS. 10, 11 and 12 show the ability of the example carrier 210 from FIG. 1 to be moved from one location to another, one orientation to another, and/or from one harness to another.

FIGS. 13 and 14 show an example harness 100 from FIG. 1 wherein at least two load restraining devices 200 are operably affixed. In FIG. 13, both devices are of the same type 210; in FIG. 14 the devices are of different types 210 and 220.

FIGS. 15 through 24 show various forms of harness 100 applicable to the present invention. In FIG. 15, the harness comprises one horizontal load carrying member 110 and one vertical load carrying member 120. In FIG. 16, the harness comprises two horizontal load carrying members 110, one above the other. FIGS. 17, 18, 19 and 20 show different forms for the harness' vertical load carrying member(s) 120, shaped like a “Y” 121, “X” 122, “H” 123, and a “double H” 124, respectively.

FIGS. 21 and 22 show an example mechanism 130 for adjusting the length of an exemplary horizontal 110 and vertical 120 load carrying member(s).

FIGS. 23 and 24 show exemplary horizontal 110 and vertical 120 load carrying members wherein the members contain integral storage regions 140. The storage regions may be internal 141 or external 142, and may be sealable.

FIGS. 25 through 28 shows various examples of load restraining devices particularly suited for children/infants. In FIG. 25 the load restraining device takes the shape of a sling 211. In FIG. 26 the restraining device 212 comprises a rigid platform used as a seat. In FIG. 27 the restraining device 213 is composed of both rigid and semi-flexible members comprising leg and torso openings. In FIG. 28 the restraining device 214 is a semi-flexible shell comprising leg, arm and torso openings.

FIGS. 29 and 30 shows an alternative load restraining device 220 comprising various internal 141 and external 142 storage regions, and example collections of items 320, 330, 340 and 350 which can be transported.

### GENERAL EMBODIMENT

6.1 Overview

The field of personal carrying apparatus is replete with exemplary models of nearly all types and configurations. However, from the basic sack carried over one's shoulder, to the present day high-tech backpacks, little has changed other than the types of materials used, and the types of bindings, joints, and clips.

The present invention comprises a first ever modular approach to personal load carrying devices which offers several advantages over historic types of load carrying devices. By separating the configuration and securing of the harness from the configuration and securing of the load, the present invention increases the functionality of the harness/carrier combination while allowing for each to be independently altered without impacting the ability to carry the load. This separation also allows for completely new functionality not before considered, such as the ability to change the position and/or orientation of the load on the harness, to transfer the load from one harness to another, or to carry multiple load carrying devices on a single harness.

6.2 Traditional Personal Load Carrying Devices

6.2.1 Traditional Harnesses

Most harnesses are merely placed “around” the person without actually being secured to the person. These types of harnesses use the weight of the carried load in order to secure the harness to the person. For example, consider a typical backpack used by most children for carrying books and supplies to and from school. In these types of devices the harness consists of two shoulder straps connected across the back by the carrier. As such, the load pulls the carrier downward, forcing the straps onto the child's shoulders. Since the shoulder straps have fixed length loops, the load will force the loops to rotate until the load is at its lowest point.

Although these types of harness are common, they are not the most comfortable, especially for carrying heavy loads, or for carrying loads for long distances or long durations. As those skilled in the art are readily aware, the backpacks used by experienced hikers have a waist belt in addition to their shoulder straps. The waist belt may or may not attach to the front of the should straps, but it does circumnavigate the torso of the wearer and is attached to the carrier. Since the load in the carrier typically seeks the lowest position possible, the weight of the carrier exerts a downward force on both the shoulder straps and on the waist belt. Thus, the waist belt transfers a substantial portion of the load from the shoulders to the waist/lower back. As these waist support points are nearer to the load, they exert a much smaller moment arm or torque, and make it easier to carry larger loads for longer distances and longer durations.

6.2.2 Traditional Load Restraining Devices

Since traditional load restraining devices are integral to traditional personal load carrying devices, end-users have little to no choice of which restraining device to use with which harness. Thus, even the most comfortable, best fitting harness can be rendered worthless if its integral restraining device is ill suited for the task at hand. For instance, a custom made backpack, tailored to someone's unique physiology, is simply unsuitable for use as a front-facing child carrier. The physical parameters of these integral load restraining devices dictate their use, with the result that each person either uses a less than ideal personal load carrying device for something that it was not necessarily designed to do, or is required to purchase multiple personal load carrying devices, one for each unique task.

A further limitation of existing load restraining devices is the fact that as an integral portion of a personal load carrying device, the entire device must be manipulated in order to place a load into the restraining device, or to secure or unsecure a load, particularly with respect to those situations wherein the load must be manipulated solely by a single end-user. Referring again to the child's backpack, removal of a single item by the end-user typically requires that the entire device (harness and load restraining device) be removed in order to present access to the storage area.

With respect to those situations where the personal load carrying device is configured as a child carrier, it is currently impossible to enter or extract a child from these devices without disassembling either the carrier or the entire device. In most cases, removing the child from the end-user is a major operation fraught with peril as the child becomes completely unsecured while the end-user is still encumbered by the remnants of the harness/carrier combination. At no time is the end-user allowed to secure a child to the carrier without contemplating its attachment to the harness.

6.3 Multiply Configurable Load Carrying Apparatus

A multiply configurable load carrying apparatus overcomes the deficiencies of existing apparatus by allowing the harness and the load restraining device to be independently manipulated, and more so, to be independently secured and operated. As such the advantages of the present invention allow for:
independent operation of harness and load restraining devices
Multiple harness configurations
Multiple attachment points for attaching load restraining devices
Multiple orientations for attaching load restraining devices
Multiple types of load restraining devices
Use of multiple harnesses with a single load restraining device
Use of a single harness with multiple load restraining devices
   6.3.1 Improved Harnesses

One of the single most important advancements to the state of the art is the ability to secure the harness without requiring that a load restraining device be connected/attached to the harness. As such, for the very first time, a harness can be properly fitted and completely secured without having to worry about the placement of attachment of the load. Although this may at first sound simplistic, this is a major advantage in that each person can configure and “best-fit” a harness to their explicit physiological requirements, and can further use a harness specific to the type of job required.

6.3.2 Improved Load Restraining Devices

The present invention introduces a major advantage over current load carrying apparatus can actively select a load restraining device on its specific parameters without regard to the type of harness that will or might be used. This allows an end-user the ability to custom-select a load restraining device, and further, to change the type of load restraining device depending solely on what needs to be carried. As the parameters of the load change, the load restraining device can be either altered, or the load restraining device can be swapped out for one better meeting the requirements.

6.3.3 Advantages In Practice

As an example of the various advantages of the present invention, let us consider a young couple that has recently given birth to their second child.

Mother: height—152 cm, weight—50 kg

Father: height—193 cm, weight—105 kg

1^{st} child: boy, 1 year of age, 75 cm, 11 kg

2^{nd} child: girl, 14 weeks of age, 55 cm, 5 kg

From inspection, it is obvious that the children are of such gross physical size/weight differences that a single carrier would be ill-suited to receive both children. Likewise, inspection of the parent's physique's reveals that major modifications of any harness system would need be made to accommodate the differences in their size/weight.

The solution to this problem is not four separate systems (one for each combination of child and adult), but rather a system as proposed by the present invention wherein each adult has a uniquely adaptable harness to which a child carrier uniquely fitted for each child can be removably attached. Thus each adult can be fitted with “their” harness, and use it to carry either child, and each child can be fitted into “their” carrier and be carried in either harness.

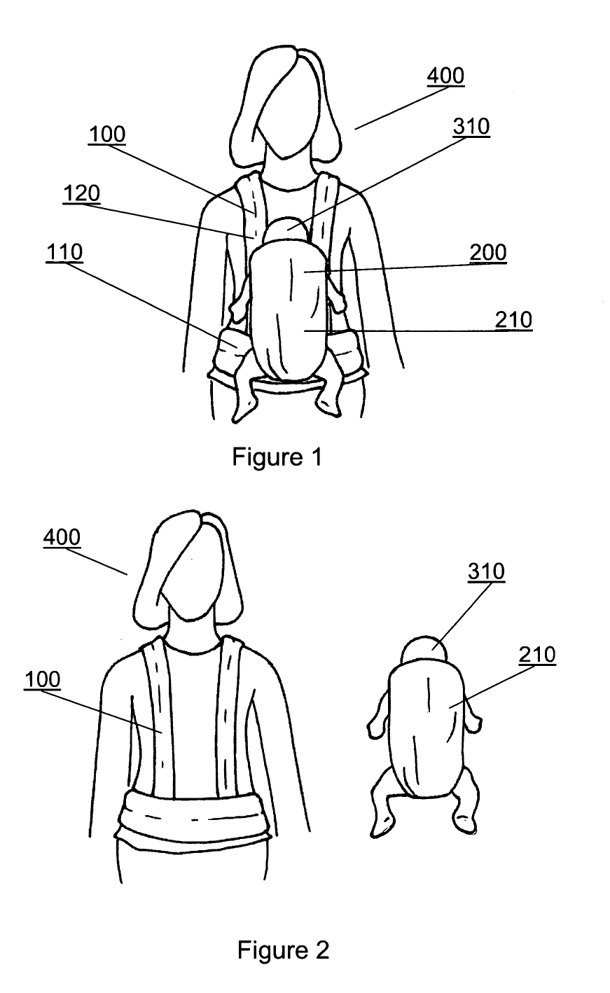

7.1 FIG. 1

FIG. 1 shows one of the preferred embodiments of the present invention comprising a harness 100, a load restraining device 200 configured to be used as an infant carrier 210, an infant 310, and a harness wearer 400. The harness 100 comprises a first member 110 which circumnavigates the harness wearer's torso, and at least one second member 120 connecting to said first member 110 at two positions in back and two positions in front of said person 400 wherein said second member 120 crosses over at least one of said person's shoulders.

7.2 FIG. 2

FIG. 2 shows the example harness 100 and infant carrier 210 from FIG. 1, and further demonstrates that the harness 100 and carrier 210 are separable without requiring that the infant 310 be removed from the carrier 210 prior to removing the carrier 210 from the harness 100.

FIG. 2 further demonstrates that the child 310 can be secured in the carrier 210 without requiring that the carrier 210 be affixed to the harness 100. Likewise the harness 100 remains secured to the person 400 without requiring the carrier 210 to be attached.

7.3 FIG. 3

FIG. 3 shows a front and back view of the example infant carrier 210 from FIG. 1. The infant carrier 210 may comprise a single or multi-piece unit, and may further comprise adjustable members for enlarging and/or tightening any of the openings. Further mechanisms for securing the child internal to the carrier (e.g., an internal belt strap) may be incorporated.

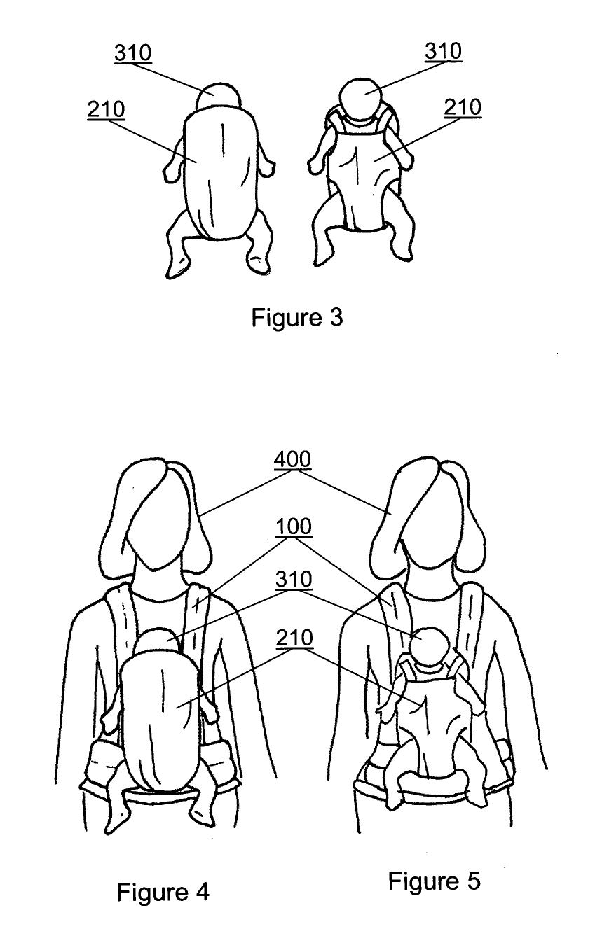

7.4 FIGS. 4 and 5

FIGS. 4 and 5 detail the ability of the example carrier 210 to be positioned either facing the person (as in FIG. 4), or facing away from the person (as in FIG. 5). Alternatively, the carrier 210 may be kept in its current orientation, and the child 310 merely re-oriented 180 degrees from a rearward facing to a forward facing position relative to the person 400, irrespective of the positioning of the carrier 210.

7.5 FIGS. 6 through 9

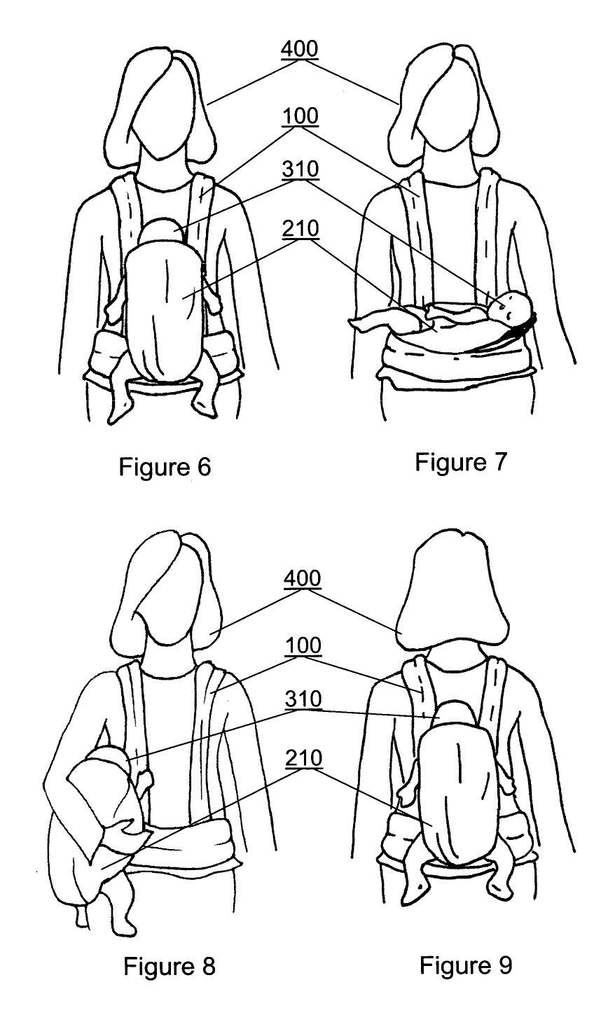

FIGS. 6 through 9 demonstrate the ability for the carrier 210 containing a child 310 to be operably affixed in multiple orientations and/or locations. Example orientations are demonstrated in FIGS. 6 and 7 wherein the carrier 210 is shown affixed either vertically (FIG. 6) or horizontally (FIG. 7). Example other locations are detailed in FIGS. 8 and 9 where the carrier 210 is shown affixed near the person's 400 hip (FIG. 8) or on the person's 400 back (FIG. 9).

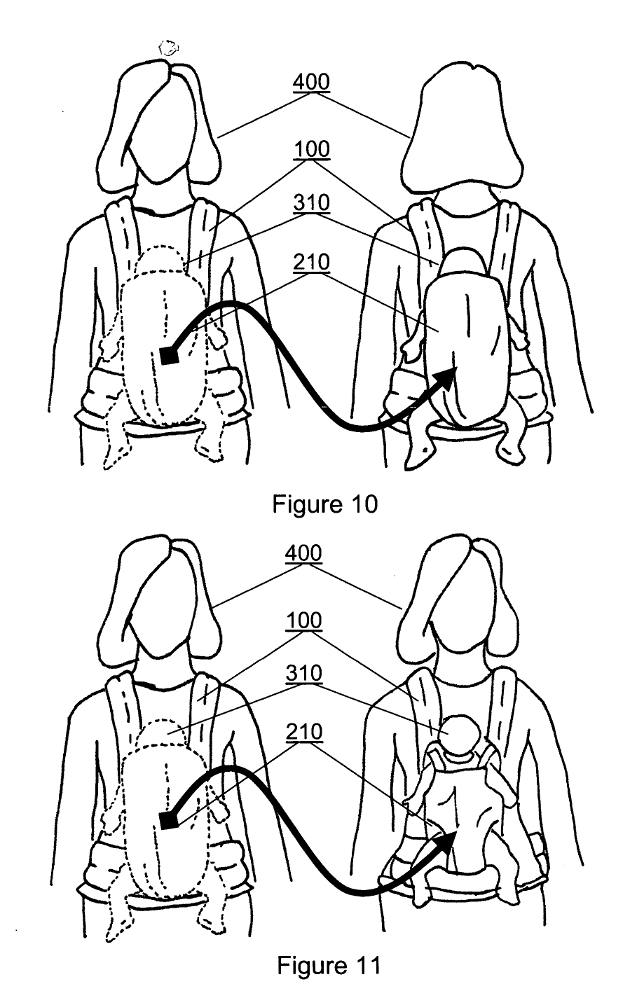

7.6 FIGS. 10, 11 and 12

FIGS. 10, 11 and 12 demonstrate the ability to change the location and/or orientation of the carrier 210 without requiring that the child 310 be removed or unsecured from the carrier 210. It is further noted that changes in location and/or orientation, and removal or attachment of the carrier 210, do not require that the harness 100 be removed or unsecured.

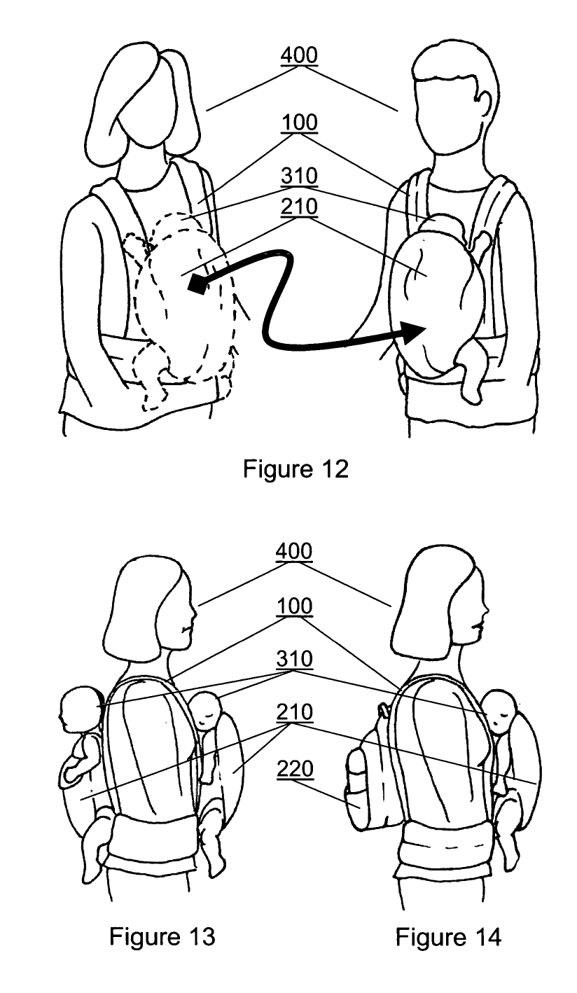

In FIG. 10, the carrier 210 containing a child 310 is moved from a first position on the chest of a person 400, to a second position on the back of the same person 400. In FIG. 11, the orientation of the carrier 210 containing a child 310 is changed with respect to the harness 100 so that the infant 310 faces forward instead of its initial position facing the person 400. In FIG. 12, the carrier 210 containing a child 310 is transferred from a first person 400 to a second person 401.

7.7 FIGS. 13 and 14

FIGS. 13 and 14 demonstrate the use of multiple load restraining devices 200 on a single harness 100. In FIG. 13 the multiple load restraining devices are represented by two similar types of carriers 210, one on the chest and one on the back, each containing one infant 310. FIG. 14 demonstrates the use of dissimilar types of load restraining devices, wherein the device affixed to the person's 400 chest is an example child carrier 210, while the device affixed to the back is a backpack like device 220.

As is obvious from the drawings, the locations and/or orientation of the various load restraining devices is independent of their type.

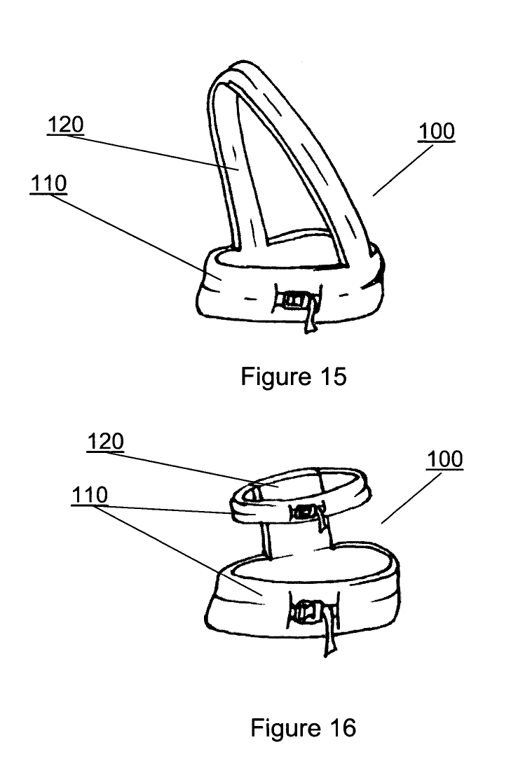

7.8 FIGS. 15 through 24

Various configurations exist for the harness 100 of the multiply configurable load carrying apparatus. Each configuration offers certain potential advantages from both a wearability point of view and/or a manufacturability point of view. The example configurations detailed below are certain of the more basic configurations which may be devised, although other configurations, and variations on these designs, will be readily apparent to those skilled in the art.

The harnesses detailed may comprise a single member, or may comprise multiple members. For those instances wherein the harness comprises multiple members, the members may be permanently or operably joined and/or affixed, and may be so joined and/or affixed at the time of manufacture and/or at the discretion of the end-user. Further, the members may be rigid, flexible, semi-flexible, or some combination of rigid, flexible, and/or semi-flexible, allowing for designs that offer increased comfort, increase load bearing capabilities, or other advantages.

7.8.1 FIG. 15

FIG. 15 demonstrates a first configuration for the harness 100. It comprises one horizontal load carrying member 110 and one vertical load carrying member 120. The orientation of the vertical member 120 as shown is such that it would cross over the person's 400 shoulder at a diagonal. However, there are no restrictions on the location of the connection between the vertical 120 and horizontal 110 members. As such, the vertical member, when viewed head on, may be completely vertical, may cross from right-to-left, or may cross from left-to-right.

7.8.2 FIG. 16

FIG. 16 comprises a variation on the harness 100 wherein the harness comprises at least two horizontal members 110. Such configurations are beneficial as the lower horizontal member is the major load carrying member, and the upper horizontal member is used as an attachment point for various apparatus, e.g., tools.

7.8.3 FIGS. 17, 18, 19 and 20

The vertical load carrying member may be constructed from multiple components or may be a single integral unit. For those instances where there are multiple discrete components, the components may be removably or permanently joined through the use of various clips, fasteners or the like, at the time of manufacture or by the end user. The vertical member 120 may be permanently or operably affixed to the horizontal load carrying member(s) 110 (not shown), or one or more of the arms/legs can be permanently or operably affixed to the horizontal member(s).

In FIG. 17, the vertical members 120 are constructed in a “Y” configuration 121, wherein the stem of the “Y” is at the back of the wearer and the arms of the “Y” carry forward, crossing the shoulders of the wearer.

In FIG. 18, the vertical members 120 are constructed in an “X” configuration 122, wherein the vertical member connecting to the front left of the wearer crosses over the left shoulder and then traverses diagonally across to the bottom right waist area, while the right front vertical member crosses the right shoulder and then traverses diagonally across to the bottom left waist area. The various arms/legs of this “X” configuration may be a single member, or at least two members. For those instances comprising at least two members, the members may be joined at the point were they cross, either directly or through the use of an intermediate member, or may simply overlap.

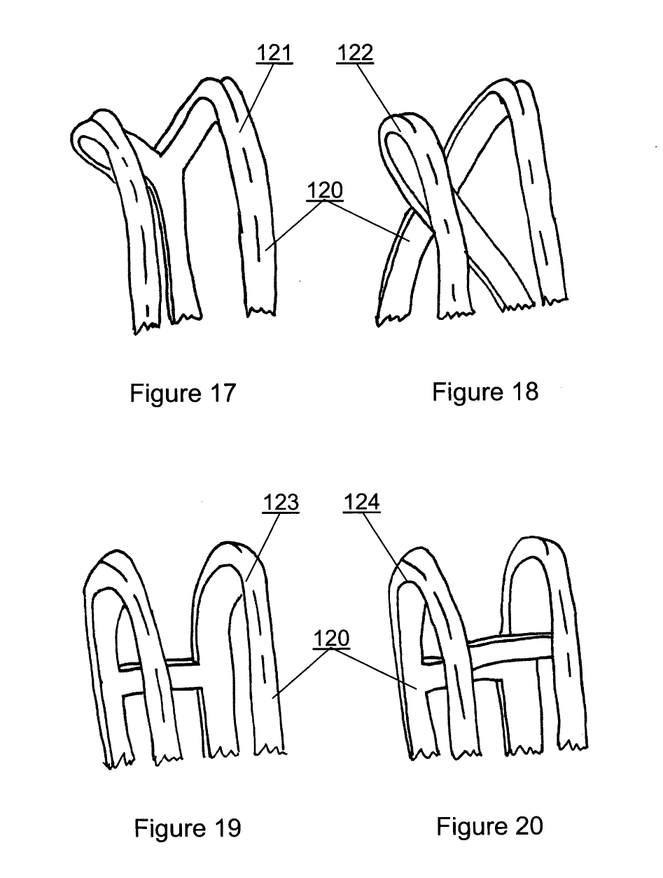

FIG. 19 comprises one of the more typical configurations for vertical member 120, wherein the members are configured in an “H” configuration 123. In this instance, the crossbar of the “H” is at the back of the user. The crossbar may be permanently affixed or may be allowed to “float” in some fashion wherein it is removably affixed at various elevations on the “H”.

FIG. 20 is a further variation on FIG. 19 wherein an additional crossbar is affixed to the front portion of the vertical member 120, in a “double H” configuration 124. Again, one or both of the crossbars may be permanently affixed, or may be allowed to float wherein they may be removably affixed at various elevations on the “H”.

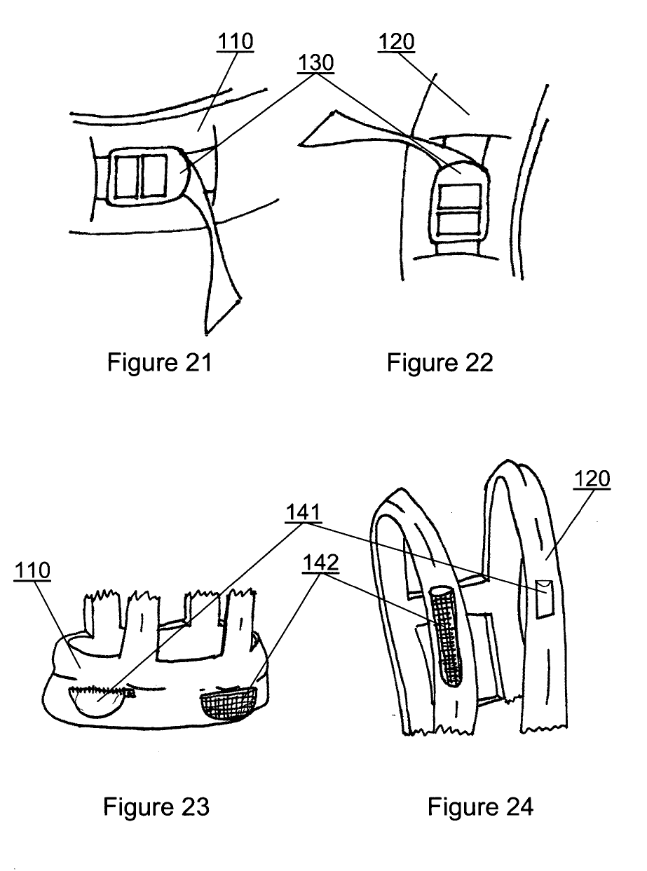

7.8.4 FIGS. 21 and 22

The length adjusting device 130 shown is but one of many possible configurations of extending/joining mechanisms by which to adjust the length of the load carrying members. As currently detailed in FIGS. 21 and 22, the extension mechanism 130 comprises two pieces, one attached to each side of the vertical 120 or horizontal 110 member, joined together by a clip. A multitude of methods and devices are known in the art for joining these two pieces together, almost all of which have fallen into common use.

7.8.5 FIGS. 23 and 24

FIGS. 23 and 24 demonstrate the ability of the horizontal 110 and vertical 120 load carrying members to incorporate integral storage regions 140. These storage regions may be internal 141 or external 142. The horizontal member 110 in FIG. 23 contains two integral storage regions, a first internal storage region 141 on the left side, sealed with a zipper, and a second external storage region 142, comprising a mesh bag. In FIG. 24, the vertical member 120 contains a narrow, deep mesh storage region 142 on the left side, and an internal storage region 141 on the right side.

As will be apparent to those skilled in the art, multiple variations on the size, shape, and location of the storage regions will exists, as well as a number of options on sealing the storage regions (e.g., zippers, buttons, Velco®).

7.9 FIGS. 25 through 28

7.9.1 FIG. 25

In FIG. 25 the load restraining device takes the shape of a sling 211 with the infant 310 capable of being held at an arbitrary angle between horizontal and approximately 45 degrees from horizontal. The sling 211 may be modified to allow the infant 310 to be held horizontally regardless of the curvature of the sling through the addition of horizontal stiffener member in the base of the sling.

7.9.2 FIG. 26

In FIG. 26 the restraining device 212 comprises a rigid platform used as a seat (pictured here without flexible/semi-flexible members used to further secure the child) preferably mounted to the side or front of the harness. Typical, short-term use of a side seat would not normally merit the use of additional restraints as the parent or care giver would normally hold the child with one hand. However, this seat could readily be positioned in the back or front of the adult, and would then benefit from additional restraints to insure the safety of the child.

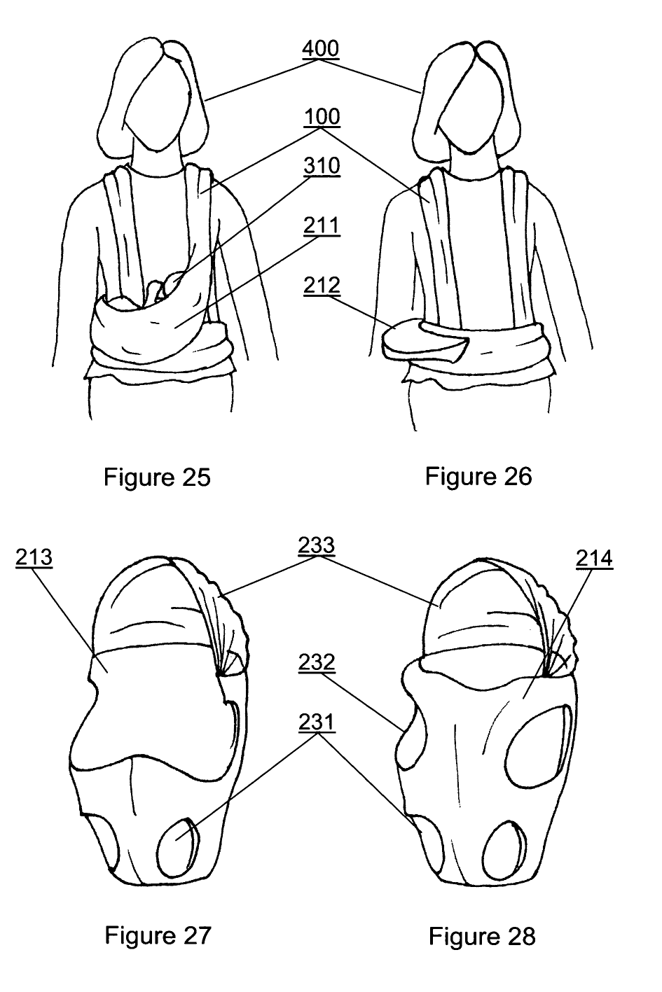

Additionally, the “side seat” could be readily modified to incorporate restraining devices 213 or 214 as shown in FIG. 27 or 28.

7.9.3 FIGS. 27 and 28

In FIG. 27 the restraining device 213 is composed of both rigid and semi-flexible members comprising leg 231 and torso openings. In FIG. 28 the restraining device 214 is a semi-flexible shell comprising leg 231, arm 232 and torso openings. As shown, both models incorporate a removably attachable sun shading device 220.

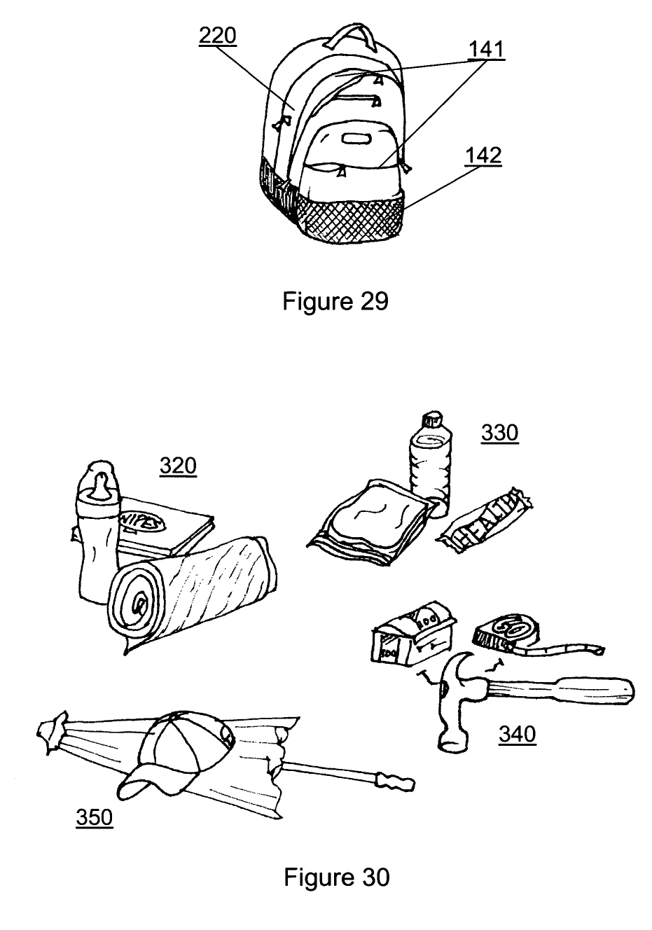

7.10 FIGS. 29 and 30

FIGS. 29 and 30 shows an alternative load restraining device 230 comprising multiple internal 141 and external 142 storage regions, and example collections of items such as infant supplies 320, food and water 330, tools 340, and clothing and sun protective gear 350, respectively, which can be transported.

We claim:

1. A carrying device for use by a person in carrying a load comprising:
a harness, and
a removably attachable load restraining device,
wherein a child is positioned and secured in said load restraining device without the need of said load restraining device to be operable affixed to said harness.

2. A device as in claim 1 wherein said harness can be secured to said person without requiring the attachment of said child restraining device.

3. A device as in claim 1 wherein said load restraining device, operably affixed to said harness, positions the child facing towards said person.

4. A device as in claim 1 wherein said load restraining device, operably affixed to said harness, positions the child facing away from said person.

5. A device as in claim 1 wherein said load restraining device, operably affixed to said harness, positions the child in a mostly vertical fashion.

6. A device as in claim 1 wherein said load restraining device, operably affixed to said harness, positions the child in a mostly horizontal fashion.

7. A device as in claim 1 wherein said load restraining device can be positioned at one of multiple locations on said harness.

8. A device as in claim 7 wherein one of said multiple locations is on said person's chest.

9. A device as in claim 7 wherein one of said multiple locations is on said person's back.

10. A device as in claim 7 wherein one of said multiple locations is near said person's hip.

11. A device as in claim 1 wherein said load restraining device can be removed from a first position on said harness and operably affixed to a second position on said harness without the child becoming unsecured.

12. A device as in claim 1 wherein said load restraining device can be removed from a first position on said harness and operably affixed to a second position on said harness without having to remove the child from said restraining device.

13. A device as in claim 1 wherein said load restraining device can be reoriented from a first orientation to a second orientation without the child becoming unsecured.

14. A device as in claim 1 wherein said load restraining device can be reoriented from a first orientation to a second orientation without having to remove the child from said restraining device.

15. A device as in claim 1 wherein said load restraining device can be removed from first person wearing a first harness and operably affixed to a second person wearing a second harness without the child becoming unsecured.

16. A device as in claim 1 wherein said load restraining device can be removed from first person wearing a first harness and operably affixed to a second person wearing a second harness without having to remove the child.

17. A device as in claim 1 wherein said load restraining device can be removed from first person wearing a first harness and operably affixed to a second person wearing a second harness, wherein the position on the second harness differs from the position on the first harness.

18. A device as in claim 1 wherein said load restraining device can be removed from first person wearing a first harness and operably affixed to a second person wearing a second harness, wherein the orientation on the second harness differs from the orientation on the first harness.

19. A device as in claim 1 wherein at least two load restraining devices are simultaneously operably affixed to said harness.

20. A device as in claim 19 wherein said at least two load restraining devices are of different types.

21. A device as in claim 1 wherein said harness comprises at least two members, at least one first member circumnavigating said person's torso, and at least one second member connecting to said first member in at least two positions, wherein said second member crosses over at least one of said person's shoulders.

22. A device as in claim 21 wherein said at least one first member is comprised of multiple component members.

23. A device as in claim 21 wherein said at least one second member is comprised of multiple component members.

24. A device as in claim 21 wherein said harness comprises at least two first members circumnavigating said person's torso.

25. A device as in claim 21 wherein said at least one second member(s) form a “Y”.

26. A device as in claim 21 wherein said at least one second member(s) form an “X”.

27. A device as in claim 21 wherein said at least one second member(s) form an “H”.

28. A device as in claim 21 wherein said at least one second member(s) form a double “H”.

29. A device as in claim 21 wherein said at least one first member is adjustable for length.

30. A device as in claim 21 wherein said at least one second member is adjustable for length.

31. A device as in claim 21 wherein said at least one first member has at least one storage compartment.

32. A device as in claim 21 wherein said at least one second member has at least one storage compartment.

33. A device as in claim 1 wherein said load restraining device comprises at least one rigid member.

34. A device as in claim 1 wherein said load restraining device comprises at least one flexible member.

35. A device as in claim 1 wherein said load restraining device comprises at least one semi-flexible member.

36. A device as in claim 1 wherein said load restraining device comprises some combination of rigid, flexible and/or semi-flexible members.

37. A device as in claim 1 wherein said load restraining device comprises a sling-like member.

38. A device as in claim 37 wherein said sling-like member further comprises a firm foundational layer so as to allow a child to lay flat.

39. A device as in claim 1 wherein said load restraining device comprises a platform for seating.

40. A device as in claim 1 wherein said load restraining device comprises an enclosure consisting of an opening for each of said child's legs, and at least one opening for said child's torso.

41. A device as in claim 1 wherein said load restraining device comprises an enclosure consisting of an opening for each of said child's legs, an opening for each of said child's arms, and one opening for said child's head.

42. A device as in claim 1 wherein said load restraining device comprises at least one storage region.
